(19) United States
(12) Patent Application Publication
(10) Pub. No.: US 2003/0221937 A1
(43) Pub. Date: Dec. 4, 2003

(54) Apparatus for longitudinally orienting elongated wood chips

(75) Inventor: Matthias Graf, Bretten (DE)

Correspondence Address: FASSE PATENT ATTORNEYS, P.A., P.O. BOX 726, HAMPDEN, ME, 04444-0726, US

(73) Assignee: Maschinenfabrik J. Dieffenbacher GmbH & Co., Eppingen (DE)

(21) Appl. No.: 10/446,958

(22) Filed: May 27, 2003

(30) Foreign Application Priority Data
May 31, 2002 (DE) 102 24 497.9

(51) Int. Cl. B65G 47/24

(52) U.S. Cl. 198/396; 156/246; 198/382

(57) ABSTRACT

An apparatus for longitudinally orienting elongated particles, such as wood strands for forming orienting strand board panels, includes a pre-orienting unit with vertically arranged orienting elements, such as discs of a disc roll, a final orienting unit below the pre-orienting unit, and a forming belt below the final orienting unit. The final orienting unit includes plural sheetmetal chutes that are spaced successively along the transport direction of the forming belt and that each include plural side-by-side trough-shaped orienting channels that slope at a slope angle toward the forming belt along the transport direction. The non-oriented wood strands supplied to the pre-orienting unit are pre-oriented by falling through passages thereof, and the pre-oriented strands are then further longitudinally oriented as they slide longitudinally along the orienting channels, from which they slide without free-falling onto the forming belt. In an alternative embodiment, the pre-orienting unit can be omitted.

### PRIORITY CLAIM

This application is based on and claims the priority under 35 U.S.C. §119 of German Patent Application 102 24 497.9, filed on May 31, 2002, the entire disclosure of which is incorporated herein by reference.

### FIELD OF THE INVENTION

The invention relates to an apparatus for longitudinally orienting elongated wood chips or particularly wood strands, especially for producing oriented strand board or other panels with oriented chips or strands.

### BACKGROUND INFORMATION

Panels or sheets comprising oriented material chips, and especially panels made of oriented elongated wood strands, known as oriented strand board or oriented structural board (OSB) panels in the art, represent structural chipboard panels having higher strength characteristics than chipboard panels or sheets without purposely oriented chips.

In the production of OSB panels or sheets, relatively long elongated wood chips or strands are oriented in one or more particular directions, are spread with this orientation onto a forming belt, and then the layer or layers of these oriented strands are pressed to form panels or sheets thereof. Typically, such elongated chips or strands of wood have a length in a range from 100 to 150 mm, a width in a range from 10 to 30 mm, and a thickness in a range from 0.4 to 1.0 mm. Most commonly, such OSB panels or sheets made of these oriented wood strands have a three-layered structure. Recently, it has also become known to produce five-layered panels or sheets in order to utilize various different glue systems.

In the formation of such three-layered OSB panels, the wood strands forming the middle or core layer are oriented crosswise while the wood strands forming the two cover layers sandwiching the core layer therebetween are oriented lengthwise or longitudinally, as strands are spread and deposited with such respective orientation onto a forming belt. Due to this oriented arrangement of the strands, anisotropic characteristics or properties are achieved in the finished OSB panel. This is because wood, and thus also a wood chip or strand, typically possesses a much greater strength in the direction of the wood fibers, in comparison to the direction perpendicular to the fibers. The wood strands typically extend along the fiber direction. Thus, a high bending strength is achieved in the longitudinal direction of the OSB panel, by arranging longitudinally oriented wood chips or strands in the outer cover layers thereof, which are respectively placed under tension and under compression when a bending load is applied in the longitudinal direction of the OSB panel.

On the other hand, while the two cover layers (with their longitudinally oriented strands) do not provide as great a strength in the crosswise direction of the panel, the middle or core layer (with its crosswise oriented strands) provides an adequate bending strength of the finished panel in this crosswise direction. For special applications, it is alternatively possible to orient the strands of the cover layers in the crosswise direction, while the strands of the core layer are oriented in the longitudinal direction of the panel. It is simply necessary to know the strand orientation of the layers of the panel, in order that the panel is ultimately installed in a manner, arrangement, and orientation making proper use of the anisotropic or oriented strength properties thereof.

In tests and evaluations it has been determined that the quality or precision of the longitudinal orienting of the wood strands has a very great influence on the ultimate bending strength of the OSB panel in the lengthwise direction. For example, already a deviation of 10 to 15° of the fiber direction of the chips or strands away from the lengthwise axis of the panel (or the intended axis of the strand orientation) leads to a significant reduction of the strength characteristics. It is thus very important to achieve the most precise and uniform orientation of the wood strands. For this purpose, namely for achieving the longitudinal orientation of the wood strands, conventional chip or strand spreading machines typically employ various different mechanical devices for orienting the wood chips as the chips are being spread.

For example, European Patent Publication EP 0,175,015 discloses a mechanical apparatus for longitudinally orienting wood chips, embodied as a disc orienter. Such a disc orienter typically comprises a plurality of rotating shafts that are arranged extending horizontally over a forming belt, whereby these shafts extend crosswise relative to the longitudinal transport direction of the forming belt, and parallel and spaced apart relative to each other. Each of the shafts is equipped with a plurality of thin sheetmetal discs that are spaced from one another along the length of the respective shaft. The adjacent discs of neighboring shafts intermesh and overlap each other respectively, and thereby form longitudinally extending through-fall or through-flow passages between the neighboring discs.

The principle of the orienting function of these disc orienters is generally as follows. The through-flow passages are narrower than the length of the wood chips or strands, so that the wood strands cannot fall through the passages in a crosswise orientation. To the contrary, the wood strands can only fall through the through-flow passages when they are generally oriented with their long axis passing through the passage. The wood chips or strands that are deposited onto the disc orienter and which do not directly or immediately fall through the through-flow passages, are set into motion by the common-direction rotation of the disc rolls. As a result of this motion, the wood chips or strands move, bounce or dance along the disc rolls and thereby change their orientation until a respective strand is oriented approximately longitudinally with respect to the through-flow passage. At that point, the respective oriented strand will freely fall through the through-flow passage or slit in a generally oriented condition.

The oriented condition of the wood strands resulting on the forming belt after being deposited from such a disc orienter is not perfect, however, and could still be substantially improved. First, the orientation of the wood strands passing through the through-flow passages between the discs is not perfectly or precisely longitudinal, but instead allows a range or deviation of the strand orientation angle relative to the flow axis. Secondly, since the disc orienter is arranged at a spacing distance or height above the forming belt, it also arises that some wood chips or strands passing through the through-flow passages of the disc orienter and then free-falling “head first” and striking onto the forming belt, will then tip sideways at least partially, to land in a somewhat randomized non-longitudinal or even substantially crosswise orientation on the forming belt. This leads to undesirable deviations of the fiber longitudinal direction of the wood chips away from the intended longitudinal axis of the forming belt or of the finished panel.

A different embodiment of a known mechanical apparatus for longitudinally orienting wood chips is known from the German Patent Laying-Open Document DE 195 44 866. According to this reference, the known apparatus comprises a plurality of wall elements that are stationarily arranged parallel and vertically next to one another, as well as elongated orienting elements that are allocated to these wall elements. The orienting elements are connected to a drive and can thus carry out a motion, which comprises a motion component that is longitudinal and vertically or perpendicularly oriented relative thereto.

The German Utility Model Publication 297 07 143 discloses an apparatus for orienting and depositing elongated particles, with which the degree of orientation of the particles can be improved in connection with a high throughput capacity. For this purpose there is provided an embodiment including a mechanical orienting unit which comprises vertical orienting surfaces in the movement direction of the substrate or base, whereby neighboring ones of the orienting surfaces are drivable in opposite directions. The motion of the orienting surfaces is parallel to the moving substrate or base, and also comprises motion components vertical or perpendicular to the substrate or base for longitudinally orienting the wood chips. Such a structure and operation is relatively complicated, and still leaves room for improvement.

### SUMMARY OF THE INVENTION

In view of the above, it is an object of the invention to provide an apparatus for longitudinally orienting elongated wood chips of the above mentioned general type, which is improved so as to achieve a substantially exact lengthwise or longitudinal orientation of the wood chips, so that panels or sheets with improved strength characteristics can be produced. The invention further aims to avoid or overcome the disadvantages of the prior art, and to achieve additional advantages, as apparent from the present specification.

The above objects have been achieved according to the invention in an apparatus for longitudinally orienting elongated particles of particulate material, and especially flat elongated wood chips or strands, for the production of panels in the manner of OSB panels with oriented wood strands. The apparatus according to the invention comprises a particle supply arrangement that supplies the elongated material particles in a non-oriented condition, a movable forming belt arranged therebelow, and an orienting unit arranged over the forming belt for depositing the particles of particulate material in a longitudinally oriented manner onto the forming belt. The orienting unit comprises orienting elements in the manner of a plurality of chutes or sluices that are arranged at an inclined or sloping angle relative to the forming belt. Each one of the chutes includes trough-shaped orienting channels arranged respectively side-by-side next to one another, whereby each one of these orienting channels extends at the sloping angle toward the forming belt in a vertical plane along the conveying transport direction or longitudinal direction of the forming belt.

Further preferably according to the invention, the apparatus additionally comprises a pre-orienting unit, which includes vertically arranged orienting elements, which respectively form through-flow passages therebetween. The orienting unit including the chutes with the trough-shaped orienting channels is arranged between the pre-orienting unit and the forming belt, and therefore serves as a secondary or final orienting unit.

The initial flow of bulk particulate material, of which the particles are not oriented, i.e. are randomly oriented, preferably consists of long wood chips or strands, which typically have a length of 100 to 150 mm, a width of 10 to 30 mm, and a thickness of 0.4 to 1.0 mm. In the preferred embodiment of the inventive arrangement including a pre-orienting unit and a final or secondary orienting unit, the non-oriented input bulk flow of the wood strands supplied by the particle supply arrangement falls first onto the pre-orienting unit. This pre-orienting unit may, for example, preferably be embodied as a disc roll arrangement, or any other orienting device arrangement known in the prior art. For example, the pre-orienting unit can be conventionally constructed in accordance with the disclosure of European Patent Publication EP 0,175,015. This pre-orienting unit, by itself, would not achieve an adequate longitudinal orientation of the wood chips or strands if these strands were deposited directly on the forming belt from the pre-orienting unit. This results, as discussed above, because the wood chips can pass through the through-flow passages of the disc roll arrangement with various different orientations of the chips, and the wood chips further could tilt or fall crosswise upon striking onto the forming belt if the chips would be dropped directly from the pre-orienting unit onto the belt.

For this reason, the preferred embodiment of the invention further provides the secondary or final orienting unit arranged after the disc orienter (which operates as the pre-orienting unit), i.e. between the disc orienter and the forming belt. This secondary or final orienting unit comprises the above mentioned chutes that receive the partially pre-oriented wood strands from the disc orienter, further improve the longitudinal orientation of the received wood strands, and maintain this orientation of the wood strands all the way until the wood strands are slidingly deposited onto the forming belt. Thus, the chutes achieve an essentially complete longitudinal orientation of all of the wood strands that are spread and deposited onto the forming belt. In this regard, the invention aims to achieve a precision of the lengthwise orientation with a deviation of less than +/−10° and especially less than +/−5°, or even better than +/−3° relative to a perfect longitudinal orientation.

To achieve this, the chutes of the secondary orienting unit extend at a slope angle to the forming belt, and each chute comprises plural side-by-side trough-shaped orienting channels extending in the material flow direction of the chute and along the longitudinal conveying direction of the forming belt.

The wood chips or strands which have been pre-oriented by the disc orienter fall onto the secondary orienting unit according to the invention, and then slide downwardly along the chutes, while being progressively more perfectly aligned in the longitudinal direction as the strands slide into and along the trough-shaped longitudinally extending orienting channels. In this manner, a complete longitudinal orientation of all of the wood chips or strands of the bulk material flow is achieved. As the longitudinally oriented wood strands slide down out of the orienting channels onto the forming belt, each wood strand always strikes first with its leading end onto the forming belt while its trailing tail end is preferably still on the chute, i.e. in the orienting channel. Upon striking onto the forming belt, the respective wood strands are first decelerated or braked, and then are pulled smoothly away from the chutes at the conveying speed of the forming belt.

Through this process of withdrawing or pulling the strands away from the chutes, a still further improvement of the longitudinal orientation of the strands is achieved, because the wood strands cannot tilt or fall sideways since the trailing end of each wood strand still rests on the chute, i.e. in the trough-shaped orienting channel along which it was sliding. The frictional holding of the trailing end of the wood strand in the orienting channel, as the leading end of the wood strand is pulled away by the moving forming belt, serves to hold or turn the tail end in the downstream direction of the forming belt transport motion.

According to the more general embodiment of the invention, the above mentioned pre-orienting unit is omitted, and the non-oriented input flow of wood chips falls directly onto the orienting unit comprising the chutes with the trough-shaped orienting channels. In this embodiment, the non-oriented wood strands slide into the trough-shaped orienting channels and are thereby progressively oriented into the longitudinal direction, until they are completely longitudinally oriented upon exiting from the orienting channels and being depositing on and pulled along by the moving forming belt. In this embodiment, the chutes are preferably somewhat longer than in the other embodiment, to ensure a sufficient orienting effect.

The manner in which the wood strands are deposited onto the forming belt and pulled away from the orienting channels by the forming belt is the same in this embodiment as described above. This achieves a further improvement of the longitudinal orientation of the wood strands. This embodiment of the inventive apparatus is structurally very simple and also very economical, with low operating costs and maintenance costs, especially because it does not need to comprise any moving parts.

### BRIEF DESCRIPTION OF THE DRAWINGS

In order that the invention may be clearly understood, it will now be described in connection with example embodiments thereof, with reference to the accompanying drawings, wherein:

FIG. 1 is a schematic side view of an apparatus according to the invention including a pre-orienting unit and a final orienting unit, forming a cover layer spreading head for manufacturing OSB panels;

FIG. 2 is an enlarged schematic side view of a portion of the pre-orienting unit and the final orienting unit in the apparatus according to FIG. 1;

FIG. 3 is a schematic top plan view onto the portion of the apparatus shown in FIG. 2;

FIGS. 4A, 4B, 4C and 4D are respective enlarged sectional views of different sectional shapes of the trough-shaped orienting channels of the final orienting unit; and

FIG. 5 is a schematic side view of a further varied embodiment of an apparatus according to the invention for spreading a cover layer of an OSB panel, omitting the pre-orienting unit of the apparatus of FIG. 1.

### DETAILED DESCRIPTION OF A PREFERRED EXAMPLE EMBODIMENT AND OF THE BEST MODE OF THE INVENTION

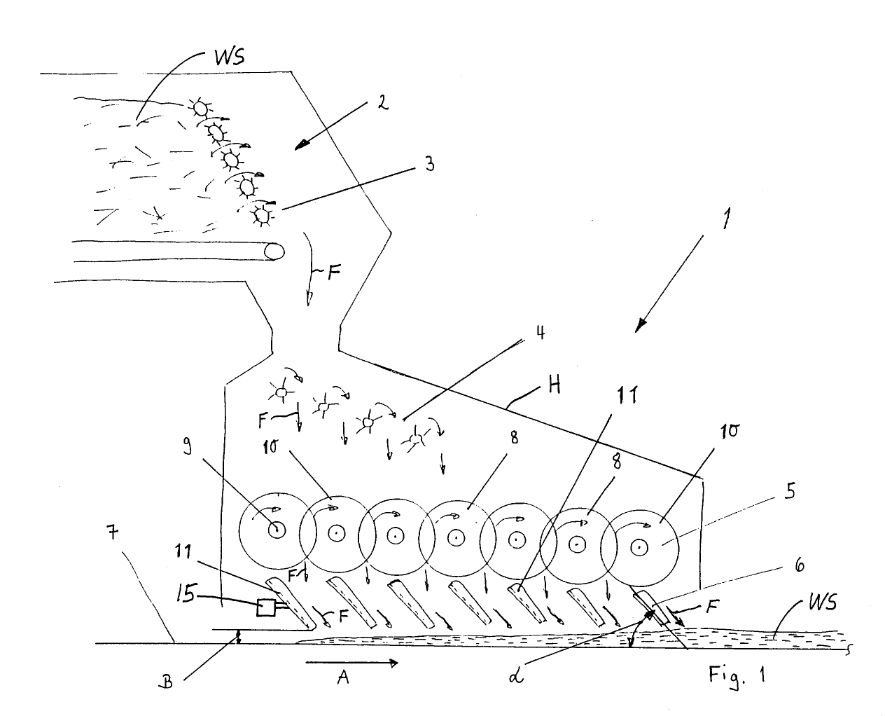

FIG. 1 schematically illustrates a forming station 1 comprising: a particle supply arrangement including a dosing hopper 2 in which a discharge roll arrangement 3 is provided, as well as pre-loosening or pre-dispersing rolls 4; a pre-orienting unit 5; a secondary or final orienting unit 6; and a forming belt 7. A bulk mass of non-oriented, flat elongated wood chips or strands WS, typically having a length of about 100 to 150 mm, a width of about 10 to 30 mm, and a thickness of about 0.4 to 1.0 mm, has previously been mixed and coated with any suitable glue or adhesive binder, and is stored and then supplied in a dosed or measured manner from the dosing hopper 2, in the form of a bulk chip material flow F through the discharge roll arrangement 3. From the discharge roll arrangement 3, the non-oriented bulk chip material flow F first falls onto the pre-dispersing rolls 4, which disperse or distribute the flow of glued chips or strands onto the pre-orienting unit 5. From the pre-orienting unit 5, the pre-oriented chip or strand flow F will then proceed to the secondary or final orienting unit 6, from which the finally oriented chips or strands are then deposited onto the forming belt 7. The details of the construction and operation of the pre-orienting unit 5 and the final orienting unit 6 will now be described.

The pre-orienting unit 5 comprises plural disc rolls 8, which are successively arranged one after another in the conveying direction indicated by the arrow A. Namely, the respective disc rolls 9 extend parallel to each other, and with their respective axes extending substantially perpendicularly across the width of the forming belt 7, namely in a transverse direction perpendicular to the transport or conveying direction A. The disc rolls 8 all rotate with a uniform constant speed in the clockwise direction, being driven by any suitable rotational drive means. Each one of the disc rolls 8 essentially consists of a rotational shaft 9 that is rotatably supported and driven in a suitable housing H, and a prescribed number of vertically oriented discs 10 arranged or mounted on the rotational shaft 9. The rotational shaft 9 passes through the center of each disc 10, substantially perpendicularly to the plane of the respective disc 10, and the discs 10 are parallel and spaced apart with respect to each other along the shaft 9 in the transverse direction. The spacing between neighboring discs 10 is uniform for all of the discs. In the illustrated embodiment, the discs 10 also all have the same outer diameter.

As can be seen especially in the enlarged partial top view of FIG. 3, the disc rolls 8 are arranged relative to each other in such a manner so that the discs 10 of adjacent rotational shafts 9 are respectively intermeshed in an overlapping manner in the interspaces of the respective neighboring disc roll 8. In this manner, each respective adjacent pair of discs 10 of the neighboring or adjacent rotational shafts 9 form a vertical through-fall or through-flow shaft or passage P, bounded by the opposite parallel discs 10.

The wood chips or strands WS falling onto the top of the pre-orienting unit 5 can fall downwardly through the through-flow passages P formed by this arrangement of the disc rolls 8 only when the strands are oriented sufficiently lengthwise or longitudinally to fit through the through-flow passages P between the adjacent discs 10. Namely, wood chips or strands that are oriented crosswise relative to the discs 10, i.e. generally parallel to the axes of the shafts 9, cannot fall down through the through-flow passages P, but instead remain supported on top of the pre-orienting unit 5.

The wood strands WS that do not immediately or directly fall down through the through-flow passages P between the discs 10, i.e. the crosswise oriented wood strands, remain supported on the disc rolls 8, and are set into motion due to the rotational movement of the disc rolls 8. As a result, the wood strands “dance” on top of the disc rolls 8 while changing their orientation until they are respectively sufficiently longitudinally oriented so that they can fall lengthwise into and through the respective through-flow passages P between the adjacent discs 10. The wood strands, as they fall down through the through-flow passages P of the pre-orienting unit 5, are forced to take on a longitudinal orientation substantially parallel to the planes of the discs 10. These pre-oriented wood strands WS then fall from the pre-orienting unit 5 onto the secondary or final orienting unit 6 arranged below the pre-orienting unit 5.

This secondary or final orienting unit 6 comprises a plurality of chutes or sluices 11 that are arranged sloping or inclined relative to the forming belt 7, generally parallel relative to each other, extending across the width of the forming belt 7 in the transverse direction substantially perpendicularly to the transport direction A, and at a small height or spacing distance B above the forming belt 7. Preferably, each chute 11 is fabricated as a sheetmetal component, and is preferably arranged sloping at an angle α of 30° to 60° (or even up to 70°) relative to the plane of the forming belt 7. Successive or neighboring ones of the chutes 11 have approximately the same spacing distance from each other in the transport direction A, which corresponds to the spacing distance of the successive rotational shafts 9 of the disc rolls 8 of the pre-orienting unit 5. Each one of the chutes 11 comprises or is provided with trough-shaped orienting channels 12 that are arranged side-by-side or successively next to one another across the width of the forming belt 7, i.e. in a transverse direction perpendicular to the transport direction A. Each one of the orienting channels 12 extends along a plane parallel to the transport direction A, and particularly extends at the slope angle α toward the forming belt 7 to intersect and merge into the transport direction A.

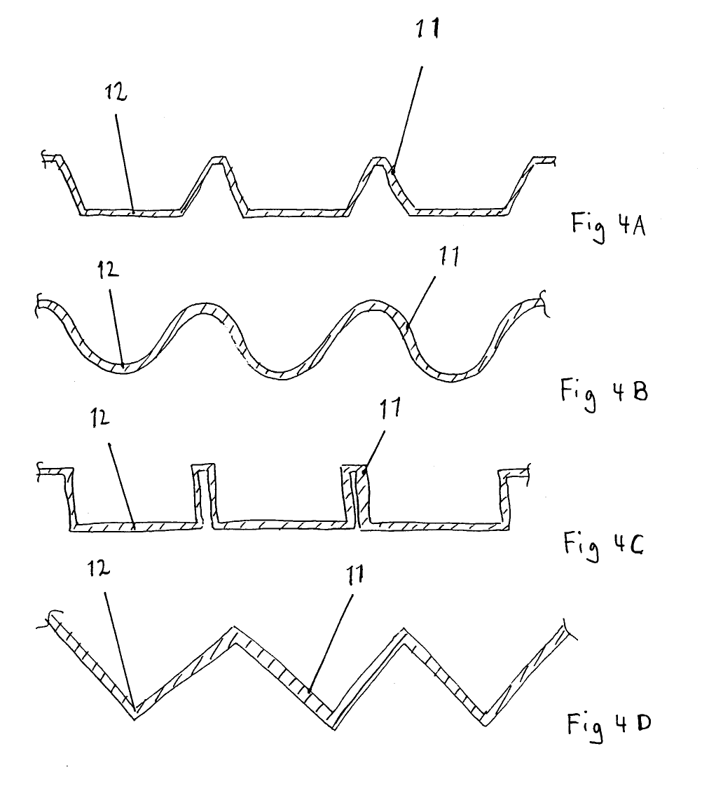

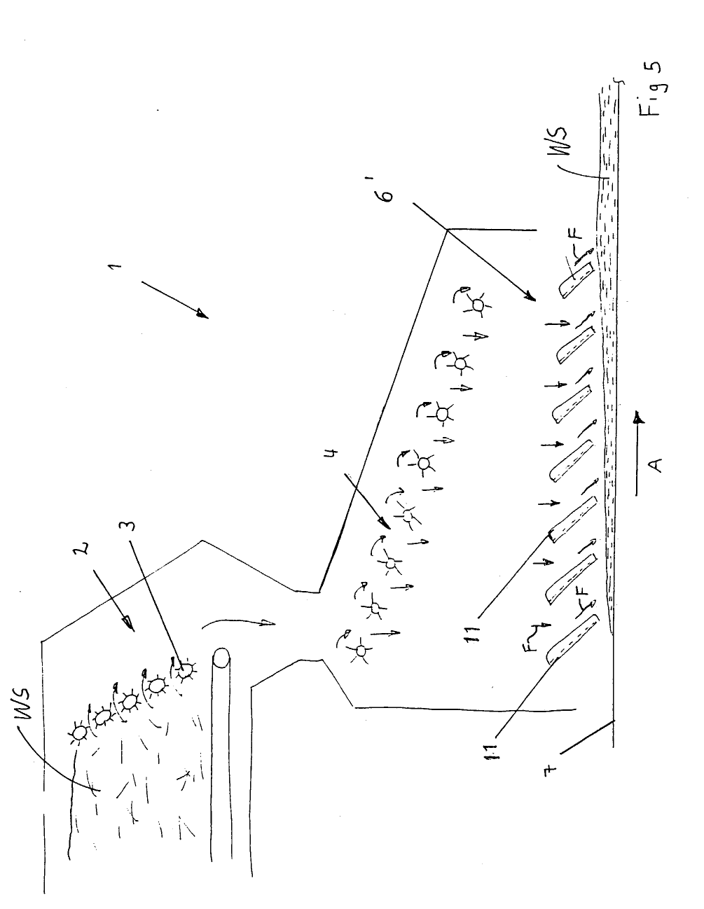

FIGS. 4A to 4D respectively show four different example embodiments of cross-sectional configurations of the orienting channels 12 that can be provided for the chutes 11. It can also be seen that each of these cross-sectional configurations of the orienting channels 12 can be fabricated by simple bending or folding operations applied to a single integral sheetmetal component to form the respective sheetmetal chute 11. More particularly, FIG. 4A shows a trapezoidal cross-sectional shape, FIG. 4B shows a sinusoidal or generally circular-segment cross-section, FIG. 4C shows a rectangular cross-section, and FIG. 4D shows a triangular cross-section, of the channels 12. In each of these cases, a portion of the respective chute 11 including three channels 12 arranged side-by-side, is illustrated. It is further possible to provide combinations of different cross-sectional shapes of the orienting channels 12 in a single chute member 11, or to provide cross-sectional shapes different from those illustrated.

While FIGS. 4A to 4D simply show a single cross-section through a representative chute 11, it should be understood that the cross-sectional shape of the chute 11 does not need to be consistent along the entire extent of the chute 11 in the material flow direction F. While such a variant is not illustrated, for example with a cross-sectional shape of the orienting channels 12 as shown in FIG. 4B, the channel depth formed by the degree of curvature or sinusoidal amplitude of the orienting channels 12 could be larger near the upper end of the chute 11 toward the pre-orienting unit 5, and smaller at the lower end of the chute 11 toward the forming belt 7. Alternatively, the exact opposite variation of the channel depth could be provided, i.e. a flatter curvature and shallower channels near the upper end and deeper channels or a stronger curvature near the lower end of the chute 11.

Each one of the chutes 11 has a length in the material flow direction of approximately one to six times (and more preferably two to five times) the length of the wood strands that are to be oriented, and have a width in the transverse direction (i.e. perpendicular to the transport direction A) corresponding to the width of the pre-orienting unit 5 arranged thereabove. The individual width of each channel 12 is preferably less than (and especially less than one half of) the length of the strands, or even substantially narrower than that, in order to enforce the strict longitudinal orientation of the strands.

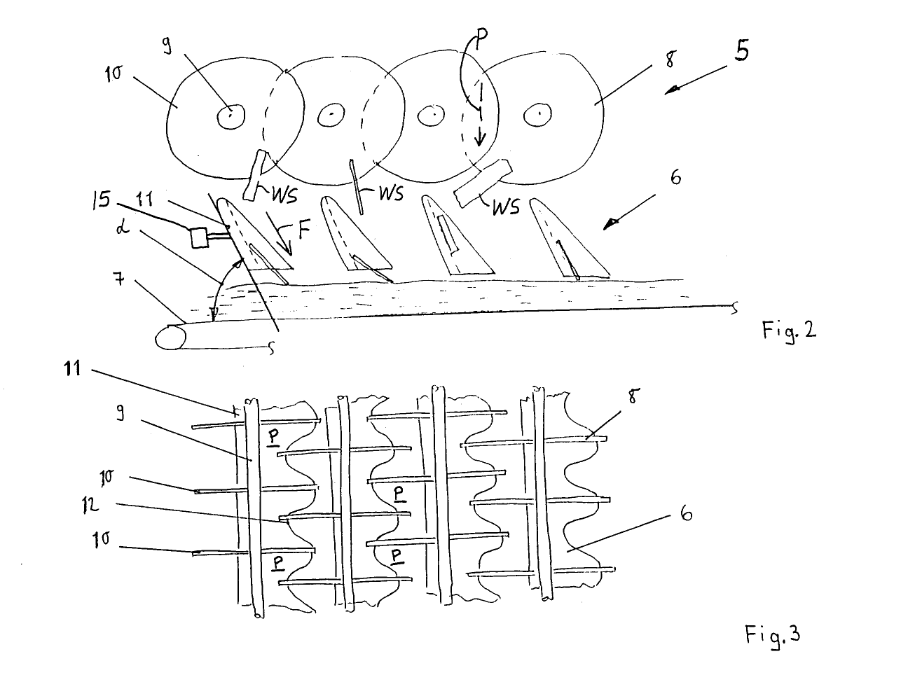

In order to prevent the wood chips or strands from becoming lodged or jammed on the upper edges of the chutes 11, these upper edges of the chutes 11, which face toward the pre-orienting unit 5, are preferably bent or curved rearwardly, for example as schematically shown in FIG. 2. Also, in one simple embodiment, the floor or base of each orienting channel 12 extends substantially linearly at the slope angle α. In an alternative embodiment, the floor or base of each orienting channel 12 does not extend linearly, but rather along a curve that is tangent to the slope angle α. Thereby, the chute 11 has a steeper slope angle at the upper entry end thereof, and a shallower slope angle at the lower discharge end thereof.

As schematically illustrated in FIG. 2, the wood strands WS that have been loosely or generally pre-oriented in the longitudinal orientation by the pre-orienting unit 5, fall from the pre-orienting unit 5 onto the secondary or final orienting unit 6. There, the wood strands WS slide longitudinally down along the several orienting channels 12 of the chutes 11, which channels 12 extend along and intersect into the transport direction A of the forming belt 7. Thereby, the wood strands WS are laid out flat and precisely oriented in the longitudinal direction parallel to the extension of the orienting channels 12, as the wood strands WS slide down along the orienting channels 12. Essentially no other orientation of the long axes of the wood strands WS is possible.

As the wood strands WS slide off of the lower discharge end of the orienting channels 12 of the chutes 11 onto the forming belt 7, the forward or leading ends of the wood strands WS always strike first onto the forming belt 7 while the tail ends of the wood strands are preferably supported on the chutes 11. At this point, the wood strands WS are first decelerated and caught by the forming belt 7, and are then pulled off of the chutes 11 at the transport speed of the forming belt 7. Thereby, the wood strands WS come to rest completely on the forming belt 7 or the layer of wood strands being deposited thereon, whereby each wood strand WS is oriented with its long axis aligned with the longitudinal direction of the forming belt, i.e. aligned with the transport direction A in which the forming belt 7 continuously runs.

A further embodiment feature of the invention is that the final orienting unit 6 may be equipped with an oscillation or vibration generator 15 as schematically indicated in FIGS. 1 and 2. The oscillation or vibration generator 15 is mechanically coupled to the chutes 11 so as to oscillate or vibrate the chutes 11, and thereby the orienting channels 12, preferably in the transverse direction perpendicular to the transport direction A. Most preferably, the oscillating motion involves an oscillation amplitude of +/− one half of the spacing or pitch of successive orienting channels 12 along the respective chute 11 in the transverse direction. Such vibration or oscillation of the chutes 11 assists in the substantially friction-free sliding of the wood strands WS along the orienting channels 12, and the discharge or drawing-off of the wood strands from the discharge end of each chute 11 onto the forming belt 7.

The arrangement of the secondary or final orienting unit 6 below the pre-orienting unit 5 is advantageously and preferably carried out so that the raised or elevated portions of the chutes 11, forming the side walls or boundaries between neighboring orienting channels 12, are located in vertical alignment with the discs 10 of the allocated disc rolls 8 located thereabove. This is schematically shown in FIG. 3. This arrangement serves to increase the statistical likelihood that the pre-oriented wood strands WS leaving the pre-orienting unit 5 will flow smoothly and directly into the respective allocated orienting channels 12 of the sheetmetal chutes 11 of the final orienting unit 6.

In order to avoid the formation of tracks or spreading patterns in the dispersed fleece or mat of the wood strands being deposited onto the forming belt 7, the invention advantageously provides that the neighboring or adjacent chutes 11 of the final orienting unit 6 are offset from one another in the crosswise or transverse direction, i.e. perpendicularly to the transport direction A. Particularly, the successive chutes 11 are preferably offset by one half of the pitch or spacing of the orienting channels 12, so that the orienting channels 12 of successive ones of the chutes 11 in the transport direction are not directly aligned with one another in the transverse direction, but rather overlap one another.

A further embodiment of an apparatus according to the invention for longitudinally orienting elongated wood chips or strands is shown schematically in a side view in FIG. 5. This apparatus according to the invention generally corresponds to that described above in connection with FIGS. 1 to 4, except that the pre-orienting unit 5 has been completely omitted. Correspondingly, the pre-orienting of the wood strands has also been omitted, and instead the bulk material flow of the non-oriented glued wood strands WS is dispersed by the pre-dispersing rolls 4 directly onto the final orienting unit 6 located therebelow. Thus, in this embodiment, the entire orienting of the wood strands is carried out by the final orienting unit 6, which is now designated as the orienting unit 6′.

The sheetmetal chutes 11 must be made somewhat longer in the material flow direction F, in comparison to the previous embodiment, so as to ensure a sufficient time for completely orienting the wood strands. Namely, in the present embodiment, the sheetmetal chutes 11 preferably have a length in the flow direction F of three to eight times the length of the wood strands that are to be oriented and dispersed. Otherwise, the same components as described above are identified with the same reference numbers in FIG. 5. The various alternative features of the previous embodiment of the final orienting unit 6 also apply to the orienting unit 6′ in the embodiment of FIG. 5.

Furthermore, in all of the above embodiments, it is possible to adjust the height of the pre-orienting unit 5, the final orienting unit 6, and/or the orienting unit 6′ (e.g. via adjustable mountings thereof in the housing H), in order to adapt the apparatus to various different panel thicknesses that are to be formed on the forming belt 7. In this regard, a common height adjustment of the pre-orienting unit 5 and the final orienting unit 6, or an individual and independent height adjustment for each of these units 5 and 6, can be provided.

The chutes 11 are preferably height-adjustably mounted in the housing H, and particularly relative to the forming belt 7. The spacing distance B (see FIG. 1) between the lower discharge edge of the chutes 11 of the final orienting unit 6 or the orienting unit 6′ relative to the forming belt 7 must be adjusted depending on the particular wood strands that are to be spread in each case. This distance B must be adjusted so that the wood strands, upon sliding off of the lower discharge edge of the chute 11 and striking with their leading ends onto the forming belt 7, will still remain resting on the sheetmetal chute 11 with their trailing or tail ends. Thereby, it is ensured that the wood strands will be pulled along by the moving forming belt 7 and thereby smoothly pulled from the orienting channels 12 in the longitudinally oriented manner. Namely this excludes the possibility of a free-fall of the wood strands from the lower end of the chute 11 onto the forming belt 7, whereby the wood strands could fall, tip or tumble into a crosswise direction, thereby destroying the intended longitudinal orientation.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. An apparatus for longitudinally orienting elongated material particles, comprising:
a particle supply arrangement adapted to supply and disperse the elongated material particles in a non-oriented condition;
a forming belt that is movably supported and drivable to move in a transport direction along a belt plane defined by said forming belt; and
an orienting unit that is arranged below said particle supply arrangement and above said forming belt, and that is adapted to longitudinally orient the elongated material particles and to deposit the elongated material particles in a longitudinally oriented condition onto said forming belt;
wherein said orienting unit comprises a plurality of chutes that each extend in a transverse direction crosswise relative to said transport direction, that are each inclined at an acute slope angle relative to said belt plane, and that each comprise a plurality of trough-shaped orienting channels which are arranged side-by-side in said transverse direction and which each extend toward said forming belt at or tangent to said slope angle in a respective plane extending along said transport direction.

2. The apparatus according to claim 1, dimensioned and adapted for longitudinally orienting said elongated material particles being wood strands having a length of 100 to 150 mm, a width of 10 to 30 mm, and a thickness of 0.4 to 1.0 mm.

3. The apparatus according to claim 1, wherein each one of said orienting channels has a channel width in said transverse direction that is less than one half of a strand length of the elongated material particles.

4. The apparatus according to claim 1, wherein said chutes are height-adjustably mounted so that a spacing distance between a lower discharge end of a respective one of said chutes and said forming belt or a previously deposited layer of the elongated material particles on said forming belt is adjustable.

5. The apparatus according to claim 1, wherein a spacing distance between a lower discharge end of a respective one of said chutes and said forming belt or a previously deposited layer of the elongated material particles on said forming belt is less than a strand length of the elongated material particles.

6. The apparatus according to claim 1, wherein each one of said chutes is a single unitary integral sheetmetal member that is bent to form said orienting channels therein.

7. The apparatus according to claim 1, wherein an upper edge of each one of said chutes is rounded, curved, or bent rearwardly opposite said transport direction.

8. The apparatus according to claim 1, wherein each one of said orienting channels has a straight linear configuration extending at said slope angle relative to said belt plane.

9. The apparatus according to claim 1, wherein each one of said orienting channels has a curved configuration extending tangent to said slope angle relative to said belt plane.

10. The apparatus according to claim 1, wherein at least some of said trough-shaped orienting channels each have a cross-sectional shape selected from the group consisting of trapezoidal shapes, rectangular shapes, square shapes, triangular shapes, sinusoidal shapes, and circular segment shapes.

11. The apparatus according to claim 1, wherein at least some of said trough-shaped orienting channels have a varying channel depth that varies from an upper entry end to a lower discharge end thereof.

12. The apparatus according to claim 1, wherein said slope angle is in a range from 30° to 70°.

13. The apparatus according to claim 1, wherein said chutes are arranged successively spaced apart from each other in said transport direction, and said chutes are arranged with said orienting channels of a first one of said chutes not being aligned in said transport direction with said orienting channels of a second one of said chutes that is adjacent to said first one of said chutes, but rather being offset in said transverse direction relative to said orienting channels of said second one of said chutes.

14. The apparatus according to claim 1, wherein said orienting unit includes no moving parts.

15. The apparatus according to claim 1, wherein said orienting unit further comprises an oscillating drive coupled to said chutes and adapted to oscillatingly move said chutes.

16. The apparatus according to claim 15, wherein said oscillating drive is arranged and adapted to oscillatingly move said chutes in said transverse direction.

17. The apparatus according to claim 16, wherein said oscillating drive is arranged and adapted to oscillatingly move said chutes back-and-forth in an oscillating motion range that corresponds to +/− one half of a pitch spacing in said transverse direction of adjacent ones of said orienting channels of a respective one of said chutes.

18. The apparatus according to claim 1, wherein said orienting unit is arranged directly between said particle supply arrangement and said forming belt so that said orienting unit receives the elongated material particles in the non-oriented condition directly from the particle supply arrangement.

19. The apparatus according to claim 18, wherein said orienting channels of said chutes have a length from an upper entry end to a lower discharge end thereof that corresponds to three to eight times a strand length of the elongated material particles.

20. The apparatus according to claim 1, further comprising a pre-orienting unit interposed between said particle supply arrangement and said orienting unit, wherein said pre-orienting unit comprises vertically extending orienting elements that bound pre-orienting through-flow passages therebetween adapted to pre-orient the elongated material particles passing therethrough from the non-oriented condition to a pre-oriented condition in which the elongated material particles are fed to the orienting unit.

21. The apparatus according to claim 20, wherein said orienting channels of said chutes have a length from an upper entry end to a lower discharge end thereof that corresponds to one to six times a strand length of the elongated material particles.

22. The apparatus according to claim 20, wherein:
said pre-orienting unit is a disc orienter that further comprises a plurality of rotational shafts that extend parallel to each other in said transverse direction;
said vertically extending orienting elements are discs that are mounted successively spaced from one another along said rotational shafts; and
said discs mounted on a first one of said shafts are offset in said transverse direction from, and overlappingly intermesh in said transport direction with, said discs mounted on a second one of said shafts adjacent to said first one of said shafts.

23. The apparatus according to claim 22, wherein said orienting unit is located and arranged below said pre-orienting unit so that raised boundaries between adjacent ones of said orienting channels of a respective one of said chutes are respectively aligned vertically below said discs mounted on a respective one of said shafts of said pre-orienting unit.

24. The apparatus according to claim 22, wherein said chutes are successively spaced from one another in said transport direction by a chute pitch spacing corresponding to a shaft pitch spacing at which said shafts are successively spaced from one another in said transport direction.
